(19) United States
(12) Patent Application Publication
(10) Pub. No.: US 2006/0094631 A1
(43) Pub. Date: May 4, 2006

(54) Cleaning composition with a coloring agent to indicate coverage

(76) Inventor: Isaac B. Horton III, Raleigh, NC (US)

Correspondence Address: Isaac B. HORTON, III, 8824 Stage Ford Road, Raleigh, NC, 27615, US

(21) Appl. No.: 11/301,968

(22) Filed: Dec. 13, 2005

Related U.S. Application Data
(63) Continuation-in-part of application No. 10/868,464, filed on Jun. 15, 2004.

(51) Int. Cl. C11D 17/08; C11D 17/00

(52) U.S. Cl. 510/421; 510/499

(57) ABSTRACT

A cleaning composition comprising a water-soluble organic solvent, at least one surfactant which comprises an amide, at least one additional surfactant, a chelating agent, a coloring agent to temporarily indicate coverage, and distilled water. The preferred embodiment of the cleaning composition consists of all-natural components.

### CROSS-REFERENCE TO RELATED APPLICATIONS

This nonprovisional utility patent application is copending with nonprovisional application Ser. No. 10/868,649 filed on Jun. 15, 2004, and nonprovisional application Ser. No. 10/868,541 filed on Jun. 15, 2004, and nonprovisional application Ser. No. 10/868,464 filed on Jun. 15, 2004; it is a continuation in part of these applications.

### BACKGROUND OF THE INVENTION

(1) Field of the Invention

The present invention relates generally to a cleaning composition and, more particularly, to an all-purpose cleaning composition for use as a spray cleaner in cleaning textiles, glass, automobiles, and hard surfaces wherein the cleaner comprises an agent which temporarily colors the cleaned surface thereby providing an indication of the specific area that has been cleaned.

(2) Description of the Prior Art

There are a large number of cleaning products currently on the market. Typically, cleaning compositions, detergents, and the like contain a combination of many components including but not limited to anionic surfactants, cationic surfactants, nonionic surfactants, builders, suds-stabilizers, buffers, disinfecting agents, wetting agents, and chelating agents. Often these cleaning compositions employ components that may have adverse effects on the environment such as phosphorous compounds, peroxygen compounds, chlorine bleach compounds, and fluorinated compounds.

Prior art related to this invention is as follows:

U.S. Pat. No. 6,720,297 issued to Jenevein on Apr. 13, 2004 for a cleaning composition teaches a cleaning composition for treating and removing stains from a non-porous surface has one or more salts, such as quaternary ammonium salts, sulfates and chlorides, a chelator and a dispersant, dissolved in an aqueous solution of alcohol. The preferred salts are myristyltrimethylammonium bromide and benzethonium chloride, the chelator is tetrasodium salt ethylenediamine of tetraacetic acid, and the dispersant is polyvinyl alcohol. The cleaning composition is incorporated into a product, which has a non-woven polyester carrier impregnated with the cleaning composition.

U.S. Pat. No. 5,759,980 issued to Russo, et al. on Jun. 2, 1998 for a car wash teaches a novel car wash composition substantially eliminates water-spotting. This novel car wash composition is comprised of: a surfactant package which is comprised of a first surfactant selected from the group consisting essentially of an anionic surfactant, a nonionic surfactant and mixtures thereof; and a second surfactant selected from the group consisting essentially of fluorosurfactant, a silicone surfactant, and mixtures thereof; and a substantive polymer that renders the surface to be cleaned more hydrophilic.

U.S. Pat. No. 6,732,747 issued to Wise on May 11, 2004 for a composition and method for cleaning and disinfecting a garbage disposal teaches an improved composition and method for cleaning and disinfecting a garbage disposal that does not require aerosol propellants or carbon dioxide gas generating reaction systems. The composition comprises a suds stabilizing surfactant and a disinfecting agent, plus other optional ingredients such as additional detergent surfactant and scouring agents. The required disinfecting agent is selected from the group consisting of quaternary ammonium compounds, halogenated compounds, phenolics, alcohols, aldehydes, oxidizing agents and mixtures thereof.

United States Patent Application Pub. No. 20040043041 to Baker, et al. on Mar. 4, 2004 for antimicrobial compositions and methods of use teaches compositions and methods for decreasing the infectivity, morbidity, and rate of mortality associated with a variety of pathogenic organisms and viruses. The reference invention also relates to methods and compositions for decontaminating areas colonized or otherwise infected by pathogenic organisms and viruses. Moreover, the reference invention relates to methods and compositions for decreasing the infectivity of pathogenic organisms in foodstuffs. In particular, decreased pathogenic organism infectivity, morbidity, and mortality are accomplished by contacting the pathogenic organism with an oil-in-water nanoemulsion comprising an oil, an organic solvent, and a surfactant dispersed in an aqueous phase. In some preferred embodiments, the solvent comprises an organic phosphate solvent. In still other embodiments, the organic phosphate-based solvent comprises dialkyl phosphates or trialkyl phosphates (e.g., tributyl phosphate).

While these compositions can lead to a useful cleaning agent, a simpler composition that retains superior cleaning activity while reducing the number of components could simplify the manufacturing process potentially reducing production costs without sacrificing product quality. Further, many of these cleaning compositions employ components that may have adverse effects on the environment.

Consumers use cleaning products on surfaces not only to remove visible soils, but also to remove invisible elements such as disease causing microorganisms. Because there is no visible indication of when these elements have been removed, i.e. when a surface is “clean,” it would be advantageous if the cleaning composition itself provided an indication of the specific area that has been cleaned. This objective would be accomplished by an agent that temporarily colors a cleaned surface. Temporary coloring agents are known in personal care compositions, such as sunscreens, where it is essential that coverage be complete and uniform. These compositions may use a pH indicator or a water-soluble dye as the coloring agent.

The following prior art is related to indicating a coverage area:

U.S. Pat. No. 5,567,420 issued to McEleney, et al. on Oct. 22, 1996 for lotion which is temporarily colored upon application teaches a lotion such as a sunscreen includes a pH indicator which colorizes the lotion until the lotion is applied to the human skin, whereinafter the colored lotion turns clear. A physiologically compatible pH indicator such as phenolphthalein is used which has a red appearance from pH 7.5+ and which has a clear appearance from about pH 7.0 to 7.5, the general pH range of the skin. The invention is suitable for use in any lotion, gel, mousse or medication that is best applied in an even and uniform manner to the skin. Accordingly, one preferred use of the invention is in UV-protecting sunscreens so that a user can ensure even distribution of the sunscreen on the body. In certain aspects of the invention, a cap houses the pH indicator and attaches to a container of the lotion, e.g a sunscreen. The pH indicator mixes with the lotion as it is applied to the skin. The invention further provides methods of manufacturing sunscreens and the like with a pH indicator that turns substantially colorless upon prolonged contact with the skin.

U.S. Pat. No. 5,747,011 issued on May 5, 1998 and U.S. Pat. No. 6,290,936 issued on Sep. 18, 2001 both to Ross, et al. and both for sunscreen with disappearing color indicator both teach a colored, sunscreen emulsion which employs a water-soluble dye or a blend of water-soluble dyes whose color substantially disappears when the sunscreen emulsion dries after it is spread on the skin and/or is rubbed out. The coloration in the sunscreen enables the user to more effectively protect against sunburn by allowing more complete and uniform coverage of the sunscreen on the skin. The sunscreen emulsion comprises: a) at least one water-soluble dye that imparts a color other than white to the sunscreen emulsion, such that when the sunscreen emulsion dries after it is spread on the skin and/or is rubbed out, the color substantially disappears; b) at least one sunscreen active in an amount effective to protect against the actinic radiation of the sun; c) at least one emulsifier; d) sufficient water to form the colored emulsion; e) optionally, one or more emollients, humectants, dry-feel agents, waterproofing agents, preservatives, antioxidants, chelating agents and fragrances as well as any other class of materials whose presence may be cosmetically, efficaciously or otherwise desirable.

### SUMMARY OF THE INVENTION

Using a water soluble dye to impart a color to a composition to temporarily indicate coverage area has been reported for use in sunscreens. See U.S. Pat. Nos. 6,290,936 and 5,747,011 which are incorporated herein by reference in their entirety. The present invention is directed to a cleaning composition for use in cleaning a range of materials including but not limited to textiles, glass, automobiles, and hard surfaces and which temporarily imparts a color to a cleaned surface to indicate coverage of the cleaning composition on that surface. Thus, the present invention provides a cleaning composition comprising a water-soluble organic solvent, at least one surfactant which comprises at least one amide, at least one additional surfactant, a chelating agent, at least coloring agent, and distilled water; thereby providing a superior cleaning composition which leaves a temporary color on a cleaned surface and which has a simple composition that is easily formulated and cost effective.

### DETAILED DESCRIPTION OF THE PREFERRED EMBODIMENTS

The present invention provides an all-purpose cleaning composition with superior cleaning ability for a range of materials including but not limited to textiles, glass, automobiles, and hard surfaces. The cleaning composition includes a coloring agent and may further include at least one preservative. The cleaning composition may further include at least one enhancing agent.

Cleaning Composition

The cleaning composition contains the following components:

(a) at least one water-soluble organic solvent present in a solubilizing effective amount;

(b) at least one amide surfactant which may be the product of the saponification of at least one fatty acid by an amino alcohol in a water-soluble organic solvent, wherein the amide surfactant is present in a cleaning-effective amount;

(c) at least one additional surfactant present in a cleaning-effective amount;

(d) a chelating agent capable of chelating multivalent metal ions, wherein the chelating agent is present in an amount effective to prevent phase reversal of the oil-in-water emulsifier;

(e) a coloring agent; and

(f) the remainder, distilled water.

Additional adjuncts in small amounts can be included to provide desirable attributes of such adjuncts. Additional adjuncts can include but are not limited to dyes, fragrances, or the like.

In the application, effective amounts are generally those amounts listed as levels of ingredients in the descriptions which follow hereto. Unless otherwise stated, amounts listed in percentages are in weight percents (%'s) of the composition.

Solvent

The solvent should be a water-soluble organic solvent. Further, the solvent is preferably a water-soluble organic alcohol. The most preferred water-soluble organic solvent is tetrahydrofurfuryl alcohol (THF-A). THF-A is an organic solvent that is completely miscible with water. THF-A has an extensive history of use as a highly versatile, high purity solvent. Due to its relatively benign nature and the fact that it is not oil-based, THF-A is generally regarded as a “green” solvent in industrial applications. THF-A readily biodegrades in soil, sludge, and water. The atmospheric half life is 13 hours. Unused THF-A is not classified as a hazardous waste under the Resource Conservation and Recovery Act.

Surfactants

The first surfactant is at least one amide. The preferred amide is at least one naturally occurring amide. The most preferred amide is a member of the group of amides comprising compounds with the structure CH₃(CH₂)ₓCONH(CH₂)₂OH, wherein the value of x is preferably any whole number between and including 14 and 22;

CH₃(CH₂)ₓCH═CH(CH₂)_{y}CONH(CH₂)₂OH, wherein the value of x+y is preferably any whole number between and including 12 and 16;

CH₃(CH₂)ₓCH═CH(CH₂)_{y}CH═CH(CH₂)_{z}CONH(CH₂)₂OH, wherein the value of x+y is preferably any whole number between and including 10 and 14; and mixtures thereof.

In another embodiment, the first surfactant may be the product of the saponification of at least one fatty acid by an amino alcohol in a water-soluble organic solvent. The preferred at least one fatty acid is chosen from the group comprising saturated fatty acids of the general formula CₓH₂ₓO₂, wherein the value of x is preferably any whole number between and including 16 and 24; monounsaturated or polyunsaturated fatty acids of the general formula CₓH_{(2x-y)}O₂, wherein the value of x is preferably any whole number between and including 16 and 20 and the value of y is preferably either 2 or 4; and mixtures thereof. A more preferred fatty acid is one chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and mixtures thereof. The most preferred fatty acid is tall oil also known as pine oil. Tall oil is commercially available as MeadWestvaco L-5, marketed by MeadWestvaco, which comprises at least 95% tall oil fatty acid and less than 5% rosin acids. Any suitable fatty acid may contain rosin acids present in small amounts not to exceed about 5% by weight of the total weight of the fatty acid. The preferred amino alcohol is an ethanolamine. The most preferred amino alcohol is monoethanolamine.

The at least one additional surfactant is preferably at least one polyethylene oxide condensate of an alkyl phenol. Suitable additional surfactants are octylphenol ethoxylates that have the chemical formula C₈H₁₇(C₆H₄)O(CH₂CH₂O)ₓH, wherein the average value of x for any mixture of these compounds is preferably any number between and including 3 and 11. Optimally two surfactant mixtures are used, wherein the average value of x for the first additional surfactant mixture is preferably 4.5, and wherein the average value of x for the second additional surfactant mixture is preferably 9.5. These preferred additional surfactant mixtures are commercially marketed under the names Triton X-45 and Triton X-100 by The Dow Chemical Company.

Chelating Agent

The chelating agent is required to chelate multivalent metal ions and thus prevent phase reversal of the oil-in-water emulsifier. The preferred chelating agent is an aminocarboxylic acid salt. The most preferred chelating agent is tetrasodium ethylenediaminetetraacetic acid (Na₄EDTA). This compound is commercially marketed as an aqueous solution of about 38% by weight Na₄EDTA under the name Versene by The Dow Chemical Company.

Coloring Agent

The coloring agent may be at least one water-soluble dye that imparts a color to the cleaning composition, such that when the cleaning composition dries after it is sprayed on the skin and/or is wiped with a cleaning cloth or sponge, the color substantially disappears. The amount of the water-soluble dye in the cleaning composition can range from about 0.0005 to about 0.5 weight percent of the cleaning composition, preferably from about 0.01 to about 0.05 weight percent of the cleaning composition.

Some suitable water soluble dyes are FDC Blue #1, FDC Blue #2, FDC Green #3, FDC Red #3, FDC Red #4, FDC Yellow #5, FDC Yellow #6, DC Green #5, DC Red #22, DC Red #28, DC Red #33, DC Yellow #10, Ext DC Violet #2, Ext DC Yellow #7, DC Green #8, DC Orange #4, DC Yellow #8.

The cleaning composition should contain the coloring agent in an amount sufficient to enable the cleaning composition to be readily visualized (i.e. colored) when initially applied to a surface, such that when the cleaning composition dries after being spread on a surface and/or is wiped with a cleaning cloth or sponge, the color substantially disappears. One or more water-soluble dyes can be employed in the composition in an amount ranging from about 0.0005 to about 0.5% by weight of the cleaning composition, preferably from about 0.002 to about 0.2%, more preferably from about 0.01 to about 0.05%, most preferably from about 0.02 to about 0.04%. Also preferred is that the coloring agent is a blend of Ext DC violet #2 (95%) and Ext DC red#3 (5%).

In another embodiment the coloring agent may be a compound which is colored at a first pH and is colorless at a second pH. In this embodiment the composition comprises the coloring agent, or indicator, and a volatile base such that the indicator is colored in the presence of the volatile base but colorless after the volatile base evaporates. Alternatively, the composition may comprise an indicator and a volatile acid such that the indicator is colored in the presence of the volatile acid but colorless after the volatile acid evaporates. By way of illustration but not limitation, one suitable pH indicator for use in the present invention is phenolphthalein.

Water and Miscellaneous

Water may be present at levels of between about 6% and about 99% by volume. The most preferred amount of water is between about 47% and about 53% by volume. Some of the amides and acids that are present in this composition are known to undergo intermolecular and intramolecular Diels-Alder cyclization reactions. Some of the products of those reactions are known to have biological activity. Because these products are present in the cleaning composition of the current invention, and these products show biological activity, no additional biocide is necessary in this composition at the higher concentrations. At the lower concentrations, a biocide or other type of preservation may be utilized to prevent deterioration. By way of example, but not limitation one of these cyclization products is cyclopinolenic acid. Additionally, small amounts of adjuncts may be added to the composition for aesthetic qualities. These adjuncts include perfumes and dyes.

Enhancing Agents

The cleaning composition may include at least one enhancing agent. By way of example, and not limitation, the at least one enhancing agent can be a skin softening and conditioning agent, a pH control agent, a malodor reducing system, an alcohol, a soil resist, an aromatherapy agent, and combinations thereof.

The invention further provides a method for formulating the cleaning concentrate. The method of formulating the cleaning composition of the present invention relies upon adherence to certain process parameters that lead to a unique product. The order of addition of the various components is critical. It is also vital that the process temperature be maintained throughout the procedure.

The composition is formulated in a reactor. The preferred reactor is a glass or Hastelloy reactor equipped with a reflux condenser and a means of stirring. The means of stirring may be a stir bar or agitator. The reactor should be clean prior to the reaction.

The reactor is charged with a water-soluble organic solvent. A suitable amount of water-soluble organic solvent is between about 3% and about 16% by weight of the total composition. The most preferred amount of water-soluble organic solvent is between about 3% and about 9% by weight of the total composition. In a preferred embodiment the water-soluble organic solvent is a water-soluble organic alcohol. In the most preferred embodiment the water-soluble organic solvent is tetrahydrofurfuryl alcohol (THF-A).

The reactor is charged with an amino alcohol. The stirring mechanism is employed while the reactor is charged with the amino alcohol. The stirring mechanism is continuously employed during the remainder of the process. A suitable amount of amino alcohol is between about 3% and about 9% by weight of the total composition. The amino alcohol undergoes a chemical reaction with the fatty acid in a 1 to 1 mole ratio. However, in the preferred embodiment the fatty acid is present in excess amounts. In a preferred embodiment the amino alcohol is an ethanolamine. In the most preferred embodiment the amino alcohol is monoethanolamine.

The contents of the reactor must be heated. The preferred temperature range for this process is between 75 and 90 degrees Celsius (C). The most preferred temperature range for this process is between 80 And 85 degrees C. This temperature range is maintained throughout the process. Immediately following additions of various components the batch temperature may fall below this range. At no time should the temperature be allowed to fall below 55 degrees C. The batch temperature should recover quickly to the required range.

At least one fatty acid is added to the reactor. A suitable amount of the at least one fatty acid is between about 7% and about 14% by weight of the total composition. The fatty acid is added via a clean gravity feed vessel. Alternatively a pump type vessel may be employed for the addition. After addition of the fatty acid the contents of the reactor are stirred for a first time period during which the reaction is monitored until it is complete. The reaction may be determined to be complete by any convenient method used in the art. Suitable methods include thin layer chromatography and high performance liquid chromatography.

After the reaction is determined to be complete, a first portion of distilled water is added rapidly. A suitable amount of the first portion of distilled water is between about 1% and about 9% by weight of the total composition. The mixture is stirred for a second time period which is sufficient to allow the composition to form a homogeneous mixture. Preferably the mixture is stirred for at least 10 minutes. The stirring time may increase dramatically corresponding with a scale-up of the process.

The at least one additional surfactant is rapidly added to the reactor. A suitable amount of each additional surfactant is between about 7% and about 30% by weight of the total composition. The most preferred amount of each additional surfactant is between about 8% and about 30% by weight of the total composition. The mixture is stirred for a time period which is sufficient to allow the composition to form a homogeneous mixture. Preferably the mixture is stirred for at least 10 minutes. The stirring time may increase dramatically corresponding with a scale-up of the process.

The chelating agent is added to the reactor. The preferred amount of chelating agent is between about 2% and about 8% by weight of the total composition. The chelating agent may be added to the present composition as an aqueous solution. In a preferred embodiment the chelating agent is added to the composition as an aqueous solution, and the chelating agent is present at a concentration of between about 36% and about 40% by weight in the aqueous solution. A commercially available aqueous solution of a chelating agent, such as Versene, may be used. A suitable amount of the aqueous solution of chelating agent is between about 7% and about 19% by weight of the total composition. The most preferred amount of the aqueous solution of chelating agent is between about 8% and about 19% by weight of the total composition.

Distilled water is added to the reactor and the composition is allowed to cool. A preferred amount of distilled water for the second addition of distilled water is between about 4% and about 44% by weight of the total composition. The composition is allowed to cool to within 25 to 30 degrees C. As the composition is cooling, the coloring agent is added to the reactor. The preferred amount of coloring agent is between about 0.01% and about 0.5% by weight of the total composition.

Optionally, after cooling and prior to commercial distribution, the composition may be passed through a filter to remove any debris acquired during the processing steps.

Certain modifications and improvements will occur to those skilled in the art upon a reading of the foregoing description. By way of example, applications for this cleaning composition may be extended to a cleaner for aircrafts which have exterior coatings similar or identical to automobiles. All modifications and improvements have been deleted herein for the sake of conciseness and readability but are properly within the scope of the following claims.

### DESIGN EXAMPLE(S)

This section outlines a design example, not necessarily optimized but illustrative of a suitable method, wherein the cleaning composition of the current invention may be formulated.

### Example

In this preferred embodiment of the method of formulating a cleaning composition in a concentrated form a reactor is charged with tetrahydrofurfuryl alcohol. A stirring mechanism is employed continuously during the remainder of the process. The reactor is then charged with monoethanolamine, wherein the volume of monoethanolamine is one half the volume of the tetrahydrofurfuryl alcohol. The contents of the reactor are heated to within the range of 80 to 90 degrees C. The reactor is charged with tall oil (MeadWestvaco L-5) acquired from MeadWestvaco. The volume of tall oil is equal to the volume of the tetrahydrofurfuryl alcohol. The contents of the reaction are stirred until the reaction is determined to be complete. The reaction progress is followed by thin layer chromatography. The reactor is charged with a first portion of distilled water, wherein the volume of the first portion of distilled water is equal to the volume of the tetrahydrofurfuryl alcohol. The contents of the reaction are stirred for ten minutes. The reactor is charged with the additional surfactants Triton X-100 and Triton X-45, acquired from the Dow Chemical Company, wherein the amount of each additional surfactant is equal to the volume of the tetrahydrofurfuryl alcohol. The contents of the reactor are stirred for ten minutes. The reactor is charged with the commercially available aqueous solution of tetrasodium ethylenediaminetetraacetic acid Versene, wherein the amount of Versene is equal to the volume of the tetrahydrofurfuryl alcohol. The reactor is charged with a second portion of distilled water, wherein the volume of the second portion of distilled water is equal to five times the volume of the tetrahydrofurfuryl alcohol, and the mixture is allowed to cool to about room temperature. As the mixture is cooling, the reactor is charged with the coloring agent.

What is claimed is:

1. A cleaning composition comprising:
(a) a water-soluble organic solvent,
(b) at least one amide surfactant,
(c) at least one additional surfactant,
(d) a chelating agent,
(e) at least one coloring agent, and
(f) the remainder distilled water.

2. The cleaning composition according to claim 1, wherein the water-soluble organic solvent is tetrahydrofurfuryl alcohol.

3. The cleaning composition according to claim 1, wherein the amount of water-soluble organic solvent is between about 3% and about 16% by weight of the total composition.

4. The cleaning composition according to claim 1, wherein the at least one amide surfactant is the product of the saponification of at least one fatty acid by an amino alcohol.

5. The cleaning composition according to claim 4, wherein the amount of the at least one fatty acid is between about 7% and about 14% by weight of the total composition.

6. The cleaning composition according to claim 4, wherein the at least one fatty acid is chosen from the group comprising saturated fatty acids of the general formula CₓH₂ₓO₂, wherein the value of x is any whole number between and including 16 and 24; monounsaturated or polyunsaturated fatty acids of the general formula CₓH_{(2x-y)}O₂, wherein the value of x is any whole number between and including 16 and 20 and y is either 2 or 4; and mixtures thereof.

7. The cleaning composition according to claim 4, wherein the at least one fatty acid is chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and mixtures thereof.

8. The cleaning composition according to claim 7, wherein the tall oil may contain rosin acids present in small amounts not to exceed about 5% by weight of the total weight of the tall oil.

9. The cleaning composition according to claim 1, wherein the at least one amide surfactant is at least one fatty acid amide.

10. The cleaning composition according to claim 9, wherein the at least one fatty acid amide is a member of the group of amides comprising compounds with the structure CH₃(CH₂)ₓCONH(CH₂)₂OH, wherein the value of x is any whole number between and including 14 and 22; CH₃(CH₂)ₓCH═CH(CH₂)_{y}CONH(CH₂)₂OH, wherein the value of x+y is any whole number between and including 12 and 16;
CH₃(CH₂)ₓCH═CH(CH₂)_{y}CH═CH(CH₂)_{z}CONH(CH₂)₂OH, wherein the value of x+y is any whole number between and including 10 and 14; and mixtures thereof.

11. The cleaning composition according to claim 1, wherein the amount of the at least one additional surfactant is between about 7% and about 30% by weight of the total composition.

12. The cleaning composition according to claim 1, wherein the at least one additional surfactant is a polyethylene oxide condensate of an alkylphenol.

13. The cleaning composition according to claim 1, wherein the at least one additional surfactant is an octylphenol ethoxylate that has the formula C₈H₁₇(C₆H₄)O(CH₂CH₂O)ₓH, wherein the average value of x is any number between and including 3 and 11.

14. The cleaning composition according to claim 1, wherein the at least one coloring agent comprises at least one water soluble dye that imparts a color selected from the group consisting of purple, pink, amber, lime, olive green, beige, brown, violet, green, yellow, red, orange, teal and blue.

15. The cleaning composition according to claim 14, wherein the at least one water soluble dye is selected from the group consisting of FDC Blue #1, FDC Blue #2, FDC Green #3, FDC Red #3, FDC Red #4, FDC Yellow #5, FDC Yellow #6, DC Green #5, DC Red #22, DC Red #28, DC Red #33, DC Yellow #10, Ext DC Violet #2, Ext DC Yellow #7, DC Green #8, DC Orange #4, DC Yellow #8, and combinations thereof.

16. The cleaning composition according to claim 14, wherein the amount of the at least one water soluble dye is between about 0.0005 and about 0.5 weight percent of the cleaning composition.

17. The cleaning composition according to claim 1, wherein the at least one coloring agent comprises at least one compound which changes from colored to colorless corresponding to a change in pH.

18. A cleaning composition comprising:
(a) a water-soluble organic solvent;
(b) at least one amide surfactant, wherein the at least one amide surfactant is the product of the saponification of at least one fatty acid by an amino alcohol;
(c) at least one additional surfactant, wherein the at least one additional surfactant is a polyethylene oxide condensate of an alkylphenol;
(d) a chelating agent, wherein the chelating agent is an aminocarboxylic acid salt;
(e) at least one coloring agent, and
(f) the remainder distilled water.

19. The cleaning composition according to claim 18, wherein the at least one coloring agent comprises at least one water soluble dye imparts a color selected from the group consisting of purple, pink, amber, lime, olive green, beige, brown, violet, green, yellow, red, orange, teal and blue, and the at least one water soluble dye is selected from the group consisting of FDC Blue #1, FDC Blue #2, FDC Green #3, FDC Red #3, FDC Red #4, FDC Yellow #5, FDC Yellow #6, DC Green #5, DC Red #22, DC Red #28, DC Red #33, DC Yellow #10, Ext DC Violet #2, Ext DC Yellow #7, DC Green #8, DC Orange #4, DC Yellow #8, and combinations thereof.

20. The cleaning composition according to claim 18, wherein the at least one coloring agent comprises at least one compound which changes from colored to colorless corresponding to a change in pH.
